(19) United States
(12) Patent Application Publication
(10) Pub. No.: US 2024/0149315 A1
(43) Pub. Date: May 9, 2024

(54) MICROWAVE HEATING SYSTEM AND PROCESS FOR DESORPTION OF CONTAMINATED SOIL

(71) Applicants: Min-Hang WENG, Kaohsiung City (TW); MEI LIN ENERGY TECHNOLOGY Co., Ltd., Kaohsiung City (TW)

(72) Inventors: Tsung-Chih YU, Kaohsiung City (TW); Tung-Chieh YANG, Kaohsiung City (TW); Wu-Yeh LEE, Kaohsiung City (TW); Min-Hang WENG, Kaohsiung City (TW)

(21) Appl. No.: 18/462,590

(22) Filed: Sep. 7, 2023

(30) Foreign Application Priority Data
Nov. 8, 2022 (TW) 111143459

(51) Int. Cl. B09C 1/06

(52) U.S. Cl. CPC B09C 1/06

(57) ABSTRACT

The present invention discloses a microwave heating system for desorbing contaminated soil, comprising: a feeding module; a heating cavity; a first microwave suppression cavity; a second microwave suppression cavity; a conveyor belt; a feeding device; and an exhaust module. The feeding device is arranged above the first microwave suppression cavity or the second microwave suppression cavity, and the feeding device contains a microwave absorber material. The invention further discloses a microwave heating process for desorption of polluted soil. With the microwave heating system and process for desorbing contaminated soil, the contaminated soil can be heated quickly and uniformly, and quickly cooled and taken out smoothly.

### TECHNICAL FIELD

The present invention relates to a microwave heating system and process, more particularly to a microwave heating system and process for desorbing contaminated soil.

### BACKGROUND

Traditional heating methods, such as flame, hot air, electric heating, steam, etc., all use the principle of heat conduction to transfer heat from the outside of the heated object to the inside, gradually increasing the center temperature of the object. It takes a certain amount of time for the center of the substance to reach the desired temperature, and it will take longer for objects with poor thermal conductivity.

Microwaves are electromagnetic waves with a frequency of 300 MHz to 300 GHz, and are usually used in radar and communication technologies as information transmission. In recent years, it has also been used in various industries and agriculture for heating, drying or cracking substances. Commonly used microwave power frequencies are 915 MHz and 2450 MHz, which can cause the molecules of polar substances to rub against each other to generate heat and generate heat. In use, the microwave mode can be selected according to the shape, size and water content of the heating material. Microwave heating is to make the object to be heated itself a heating body, without the process of heat conduction. And the inside and outside are heated at the same time, so the heating effect can be achieved in a short time. When microwave heating, the electromagnetic wave can usually penetrate all parts of the object evenly to generate heat, so the uniformity is greatly improved. In microwave heating, microwave energy can only be absorbed by the heated object to generate heat, and the air in the heating room and the corresponding container will not be heated, so the thermal efficiency is extremely high, and the production environment is also significantly improved.

Waste gas, waste water and solid waste from human production and living are discharged to the soil system. When the amount exceeds the self-purification capacity of the soil, it will destroy the balance of soil composition structure and soil function. Industries involving organically polluted soil mainly include petrochemicals, iron and steel, coking, paint and coating manufacturing, pesticide production, rubber product manufacturing, leather shoe manufacturing, wood-based panels and wooden furniture manufacturing, automobile and parts spraying, and electronic product manufacturing. How to carry out land remediation and restoration of industrially polluted soil is the most realistic and urgent problem. At present, thermal desorption technology, especially rotary kiln thermal desorption technology, is mainly used for remediation of organic polluted soil. Thermal desorption technology refers to the process of using thermal energy to heat the polluted medium and the organic pollutants contained therein to about 300-550° C. to volatilize or separate the pollutants from the polluted medium, such as soil. However, the traditional thermal desorption technology uses external heat energy indiscriminately to heat the soil through conduction, convection and radiation heating methods, so that the soil matrix, soil moisture and organic pollutants can be heated at the same time, which not only makes the treatment process high energy consumption and flue gas volume, but also increases the equipment pressure and scale.

Microwave heating has non-thermal effects such as microwave catalysis, which can make organic matter active, promote its cracking and decomposition, and accelerate its gasification and separation. Therefore, microwave heating can reduce the energy consumption of the treatment, preserve the physical and chemical properties of the soil, and meet the standards of residential land, park green space, and industrial and commercial land after remediation of organic polluted soil, and solve the problems of high energy consumption, large amount of waste gas, large secondary pollution, and soil reuse in traditional technologies.

Microwave equipment is divided into batch type and continuous type. However, the capacity of using batch microwave equipment to treat soil desorption is not large enough. It is best to use continuous type to speed up the entire feeding and discharging process. However, in the heating process of microwave heating equipment in the past, not all materials can effectively absorb microwaves, causing the temperature rise of the material heating process to be too slow.

In past, in U.S. patent Ser. No. 10/427,194B2, it discloses that carbon-based microwave absorption additives are first added to polluted soil, which can increase microwave absorption and help remove hydrocarbons. In the U.S. Pat. No. 10,518,303B2, it discloses that the continuous type microwave heating method is adopted to speed up the entire feeding and discharging process, and a microwave attenuation structure is mainly proposed to protect the microwave leakage suppression of the feeding section and the discharging section.

However, in practice, a large number of soil materials have different initial scales and states, such as bundles, agglomerates, granules, powders, etc., so the soil materials may cause material jams or uneven arrangement when transporting into the chamber by the conveyor belt, and result in uneven heating of materials or uneven feeding and discharging. Even if the microwave absorbing material is added, it may still cause nonuniform heating of the soil material due to the nonuniform addition process of microwave absorbing material, so that the desorption effect is uneven. Especially contaminated soil may have clumps or stones that need to be dealt with first to facilitate subsequent soil remediation. On the other hand, the soil temperature after microwave heating may be as high as 200 degrees or more, and there will be a danger of high-temperature dust when discharging, which is also a problem to be solved in current practice.

In view of the above problems, it is necessary to propose a microwave heating system and process that can be used to desorb contaminated soil to solve the above problems.

### SUMMARY

The main purpose of the present invention is to propose a microwave heating system for desorbing contaminated soil, which has relatively large inlet opening and outlet opening, and can safely handle a large number of soil materials with different initial scale states without microwave leakage. Thus, the soil material can be smoothly fed into the microwave heating cavity, and the microwave absorbing material can be uniformly added in the most efficient way at the appropriate position, so that soil material can be heated evenly and quickly, and before the soil material is discharged, appropriate processing mechanisms are used to cool down the soil for smooth and safe discharge.

The another goal of the present invention is to propose a microwave heating process for desorbing contaminated soil, which has relatively large inlet opening and outlet opening, and can safely handle a large number of soil materials with different initial scale states without microwave leakage. Thus, the soil material can be smoothly fed into the microwave heating cavity, and the microwave absorbing material can be uniformly added in the most efficient way at the appropriate position, so that soil material can be heated evenly and quickly, and before the soil material is discharged, appropriate processing mechanisms are used to cool down the soil for smooth and safe discharge.

In order to achieve the above-mentioned main invention, the invention proposes a microwave heating system for desorbing contaminated soil, comprising:
a feeding module for crushing and sieving a pre-processed material into a crushed homogeneous material, the moisture content of the crushed homogeneous material is between 5% and 40%, and the particle size of the crushed homogeneous material is not greater than 5 cm;
a heating cavity, the heating cavity has a plurality of microwave power sources, and has a material inlet opening and a material outlet opening on opposite sides;
a first microwave suppression cavity, docked with the inlet opening of the heating cavity, and the first microwave suppression cavity contains a plurality of suppression structures;
a second microwave suppression cavity, docked with the outlet opening of the heating cavity, and the second microwave suppression cavity contains a plurality of suppression structures;
a conveyor belt, for transporting the crushed homogeneous material that needs to be heated by microwaves from the feeding module, entering the first microwave suppression cavity, then entering the heating cavity, and finally entering the second microwave suppression cavity before outputting;
a feeding device, arranged above the inside of the first microwave suppression cavity or the second microwave suppression cavity, and the feeding device contains a microwave absorbing material; and
an exhaust module, connected to the heating cavity, used to discharge the gas generated by heating the crushed homogeneous material out of the heating cavity.

According to one feature of the invention, the feeding module includes a crushing mechanism for crushing the pre-processed material into a crushed material with a particle size not greater than 5 cm; and a sieving mechanism for passing the crushed material through the sieving mechanism to obtain the crushed homogeneous material.

According to one feature of the invention, the feeding device is arranged above the inside of the first microwave suppression cavity, and has a spraying element which can spray and add the microwave absorbing material to the crushed homogeneous material on the conveyor belt.

According to one feature of the invention, the feeding device is arranged above the interior of the first microwave suppression cavity, and is a fluid pipeline with a plurality of openings to spray and add the microwave absorbing material to the crushed homogeneous material on the conveyor belt.

According to one feature of the invention, the feeding device is arranged above the inside of the second microwave suppression cavity, and has a spraying element which can spray and add the microwave absorbing material to the crushed homogeneous material on the conveyor belt.

According to one feature of the invention, the feeding device is arranged above the inside of the second microwave suppression cavity, and is a fluid pipeline with a plurality of openings, and the microwave absorbing material is sprayed and added to the crushed homogeneous material on the conveyor belt.

In order to achieve the above-mentioned another invention, the invention proposes a microwave heating process for desorbing contaminated soil, comprising the following steps:
crushing and sieving a pre-processed material into a crushed homogeneous material, the moisture content of the crushed homogeneous material is between 5% and 40%, and the particle size of the crushed homogeneous material is not greater than 5 cm;
using a conveyor belt to send the crushed homogeneous material into a heating cavity for microwave heating to above 150 degrees; and
discharging a gas generated after microwave heating the crushed homogeneous material out of the heating cavity.

According to one feature of the invention, the crushed homogeneous material further includes a step of before entering the heating cavity:
spraying a first microwave absorbing material onto the crushed homogeneous material.

According to one feature of the invention, the crushed homogeneous material further includes a step of after entering the heating cavity:
spraying a second microwave absorbing material onto the crushed homogeneous material.

According to one feature of the invention, the soil plasticity index of the crushed homogeneous material is lower than 10. In summary, the microwave heating system and process of the presented invention has the following effects:
1. Easy to manufacture and integrate the system;
2. Cost reduction of the system manufacturing;
3. Rapid heating and cooling of soil materials;
4. Reaching the safe value of microwave energy;
5. Entering and exiting the microwave cavity smoothly;
6. Heating materials evenly.

### BRIEF DESCRIPTION OF THE DRAWINGS

In order to make the above-mentioned and other purposes, features, and advantages of the present invention more obvious and understandable, several preferred embodiments are specifically described below, and in conjunction with the accompanying drawings, the detailed description is as follows.

FIG. 1 is a schematic side view of an embodiment of a microwave heating system for desorbing contaminated soil.

FIG. 2 is a schematic side view of the structure embodiment of the first microwave suppression chamber of the microwave heating system for desorbing contaminated soil of the present invention.

FIG. 3 is a schematic side view of the structure embodiment of the second microwave suppression chamber of the microwave heating system for desorbing contaminated soil of the present invention.

FIG. 4 is a flowchart of the microwave heating process for desorbing contaminated soil of the present invention.

### DETAIL DESCRIPTION

The present inventions now will be described more fully hereinafter with reference to the accompanying drawings, in which some, but not all embodiments of the inventions are shown. Indeed, these inventions may be embodied in many different forms and may not be construed as limited to the embodiments set forth herein; rather, these embodiments are provided so that this disclosure will satisfy applicable legal requirements. Like numbers refer to like elements throughout.

Microwaves have different effects on materials of different properties, which is beneficial to drying operations. Because water molecules absorb microwaves best, the parts of the material with high water content absorb more microwave power than parts of the material with low water content, which is the characteristic of selective heating. When drying wood, paper and other products, selective heating can achieve uniform heating and uniform drying. It is worth noting that the higher the temperature, the better the absorbency of some substances, resulting in a vicious cycle, and the local temperature rises sharply, resulting in overdrying or even carbonization. When microwave heating of such substances, attention should be paid to formulating a reasonable heating process.

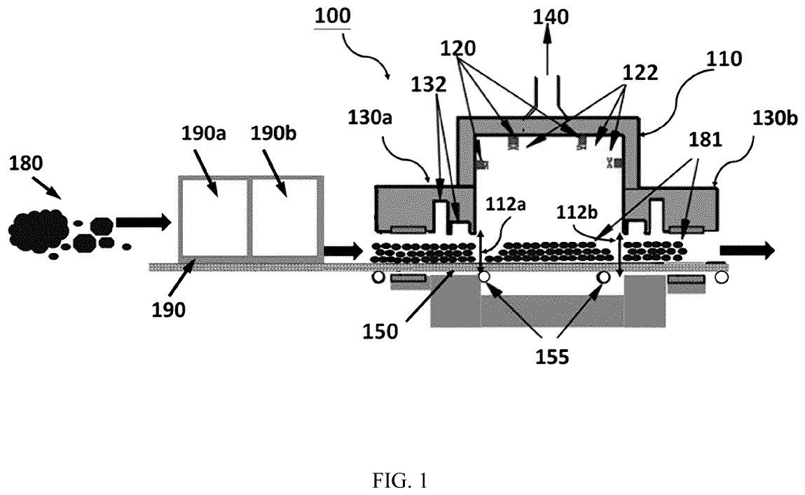

Please referring to FIG. 1, it is a schematic side view of an embodiment of a microwave heating system 100 for desorbing contaminated soil. The microwave heating system 100 for desorbing contaminated soil includes: a feeding module 190, a heating cavity 110, a first microwave suppression cavity 130 a, a second microwave suppression cavity 130 b, a conveyor belt 150 and an exhaust module 140. The black arrows in the FIG. indicate the traveling directions of a pre-processed material 180 and a crushed homogeneous material 181 after processing.

The pre-treatment material 180 includes soil polluted by volatile organic compounds, semi-volatile organic compounds, organic pesticides, petroleum hydrocarbons, polychlorinated biphenyls, and polybrominated biphenyls.

The content of organic pollutants in the crushed homogeneous material 181 is no more than 80%, preferably no more than 60%. The soil moisture content of the crushed homogeneous material 181 is between 40%-5%, preferably between 30%-15%. The particle size of the crushed homogeneous material 181 is not greater than 5 cm, preferably not greater than 3 cm, preferably no more than 3 cm, preferably less than 1 cm. The soil pH of the crushed homogeneous material 181 is not less than 3, preferably not less than 4. The soil plasticity index of the crushed homogeneous material 181 is less than 12, preferably less than 10.

The soil plasticity index is an important feature to characterize the physical properties of fine-grained soil, and it is generally represented by the plasticity index Ip. The larger the plasticity index, the finer the soil particles, the larger the specific surface area, the higher the content of clay or hydrophilic minerals (such as montmorillonite) in the soil, and the greater the range of water content in the plastic state of the soil. The plasticity index can comprehensively reflect the influence of soil mineral composition and particle size. Ip>17 clay; Ip>10 silty clay; Ip<10 or Ip=10 silt.

The feeding module 190 is used to crush and sieve a material into a crush ed homogeneous material 181, the moisture content of the crushed homogeneous material is between 40%-5%, and the particle size of the crushed homogeneous material is not greater than 5 cm. More specifically, the pre-processed material 180 is propelled into the feeding module 190 by any power, and first passed through a crushing mechanism 190a to be crushed into materials with particles smaller than 5 cm, and then entered a sieving mechanism 190b to obtain the crushed homogeneous material 181. The crushed homogeneous material 181 can be heated by microwave evenly and smoothly, and enter and exit the microwave cavity, without causing material jams or uneven arrangement, resulting in uneven heating or unsmooth discharge.

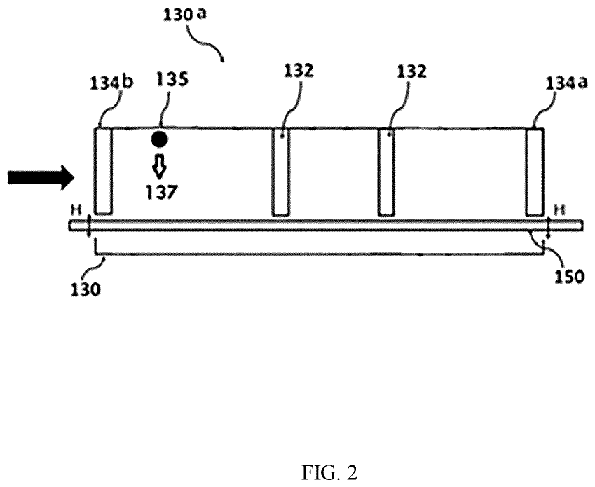

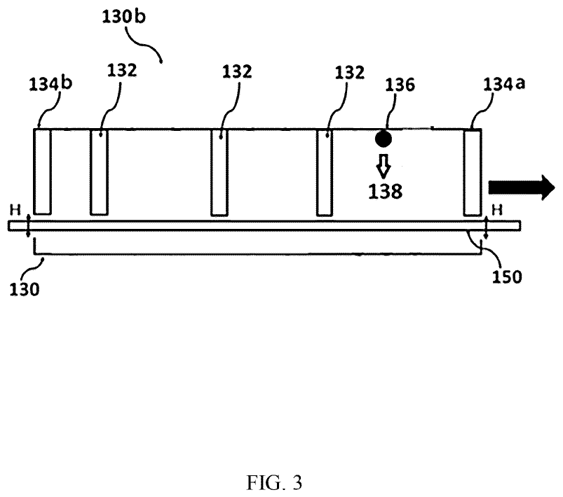

Referring now to FIG. 2 and FIG. 3, FIG. 2 is a schematic side view of the structure embodiment of the first microwave suppression cavity of the microwave heating system and process for desorbing contaminated soil of the present invention, and FIG. 3 is a schematic side view of the structure embodiment of the second microwave suppression cavity of the microwave heating system and process for desorbing contaminated soil of the present invention. It more clearly illustrates the implementation of the first microwave suppression cavity 130a and the second microwave suppression cavity 130b. The black arrows in the FIG. indicate the traveling directions of the pre-processed material 180 and the crushed homogeneous material 181.

The heating cavity 110 has a plurality of microwave power sources 120 inside, and has an inlet opening 112a and an outlet opening 112b on opposite sides of the heating cavity 110, wherein the height of the inlet opening 112a and the outlet opening 112b is between 5 cm and 50 cm. The microwave power sources 120 provide microwave energy 122 into the heating cavity 110, and the microwave frequency of the microwave power sources 120 is selected from one of 950 MHz, 2450 MHz or 5800 MHz. Since the heating cavity 110 has the inlet opening 112a and the outlet opening 112b, the heating chamber 110 needs to connect the first microwave suppression cavity 130a and the second microwave suppression cavity 130b to prevent microwave energy from leaking out from the inlet opening 112a and the outlet opening 112b of the heating cavity 110.

The first microwave suppression cavity 130a is docked with the inlet opening 112a of the heating cavity 110, and a plurality of suppression structures are included in the first microwave suppression cavity 130a; the second microwave suppression cavity 130b is docked with the outlet opening 112b of the heating cavity 110, and a plurality of suppression structures 132 are included in the first microwave suppression cavity 130a and the second microwave suppression cavity 130b. The height H of the material inlet opening 112a and the material outlet opening 112b is between 5 cm and 50 cm. Preferably, the height of the opening is between 5 cm and 20 cm.

The conveyor belt 150 is used to transport the crushed homogeneous material 181 that needs to be heated by microwaves, to enter the first microwave suppression cavity 130a, then to enter the heating cavity 110, and finally to enter the second microwave suppression cavity 130b for output. The crushed homogeneous material 181 heated by microwaves is carried on the conveyor belt 150. The conveyer belt 150 can be conveyed continuously, or conveyed step by step. Being conveyed continuously refers to forward conveying at a fixed conveying speed; and being conveyed step by step refers to advancing a certain distance each time and staying for a period of time. The black arrow in FIG. 1 is the traveling direction of the pre-proceed material 180. Since the pre-proceed material 180 is any material, such as sludge, soil, pottery, food, fruits and vegetables and other block materials or powder materials. It is polluted and contaminated soil in this embodiment.

The exhaust module 140 is connected to the heating cavity 110, and is used to discharge the gas generated after the crushed homogeneous material 181 is heated to the outside of the heating cavity 110.

Since the microwave heating system for desorbing contaminated soil of the present invention has relatively large inlet opening 112a and outlet opening 112b it is necessary to be able to safely process a large number of soil materials with different initial scale states without microwave leakage. In FIG. 2 and FIG. 3, the first microwave suppression cavity 130a and the second microwave suppression cavity 130b contain a plurality of suppression structures 132. The suppression structures 132 are arranged on the microwave suppression cavities 130 from top to bottom. The suppression structures 132 can also be up, down, left, and right inside the microwave suppression cavity 130. It should be noted that the lengths of the suppression structures 132 are shorter than the heights of the microwave suppression cavities 130. Moreover, the suppression structures 132 do not contact the conveyor belt 150.

In one embodiment, the suppression structures 132 are metal sheets, preferably a plurality of metal sheets. In another embodiment, the suppression structures 132 are made of soft materials, but soft materials that can absorb microwaves, such as carbon-containing soft materials. In one embodiment, the restraining structures 132 are made of a soft material capable of absorbing microwaves on the entire surface, and are cut and separated in multiple sections from bottom to top. That is to say, the suppression structures 132 are a whole piece of suppression structures, which are cut into multiple pieces and hung from top to bottom above the first microwave suppression cavity 130a and the second microwave suppression cavity 130b to hang down. The crushed homogeneous material 181 can push away the suppression structures 132 when being heated on the conveyor belt 150.

The outermost ends of the first microwave suppression cavity 130a and the second microwave suppression cavity 130b are provided with soft conductive materials 134a, which are suspended from the first microwave suppression cavity 130a and the second microwave suppression cavity 130b. Moreover, a soft conductive material 134b is provided at the joints of the first microwave suppression cavity 130a with the heating cavity 110, and the joints of the second microwave suppression cavity 130b with the heating cavity 110, and is hanged on the first microwave suppression cavity 130a and the second microwave suppression cavity 130b to hang down. The outermost ends of the first microwave suppression cavity 130a and the second microwave suppression cavity 130b are further provided with openable and closable metal gates (not shown in the FIG.). In one embodiment, the crushed homogeneous material 181 heated by microwaves on the conveyor belt 150 is heated to above 120 degrees, preferably above 200 degrees, more preferably above 280 degrees.

The present invention can uniformly add microwave absorbing material in the most efficient way at the appropriate position, so that it can be heated evenly and rapidly. In FIG. 2, a first feeding device 135 is arranged above the inside of the first microwave suppression cavity 130a, and the first feeding device 135 contains a microwave absorbing material. The first feeding device 135 sprays and adds the microwave-absorbing material to the crushed homogeneous material 181 heated by microwaves on the conveyor belt 150, and the spraying direction 137 is shown by the hollow arrow in FIG. 2, that is, the spraying direction 137 is generally downward. The weight of the microwave absorbing material sprayed onto the conveyor belt 150 is less than one-fifth of the weight of the crushed homogeneous material 181 on the conveyor belt 150.

The present invention can adopt appropriate processing mechanisms to cool down the soil to discharge smoothly and safely before discharging. In FIG. 3, a second feeding device 136 is disposed above the second microwave suppression cavity 130b, and the second feeding device 136 contains a microwave absorbing material. The second feeding device 136 sprays and adds the microwave absorbing material to the crushed homogeneous material 181 on the conveyer belt 150, and the spraying direction 138 is shown by the hollow arrow in FIG. 3, that is, the spraying direction 138 is generally downward. The weight of the microwave absorbing material sprayed on the conveyor belt 150 is less than one-fifth of the weight of the crushed homogeneous material 181 on the conveyor belt 150.

In one embodiment, the microwave absorbing material contained in the first feeding device 135 is water, and the microwave absorbing material is sprayed and added to the crushed homogeneous material 181 heated by microwaves on the conveyor belt 150. In one embodiment, the microwave absorbing material contained in the first feeding device 135 is an oxide material, and the microwave absorbing material is sprayed and added to the crushed homogeneous material 181 heated by microwaves on the conveyor belt 150. In one embodiment, the microwave absorbing material contained in the first feeding device 135 is one of metal strips or metal particles, and the microwave absorbing material is sprayed onto the crushed homogeneous material 181 heated by microwaves on the conveyor belt 150. Thus, the present invention can uniformly add microwave absorbing material in the most efficient way at the appropriate position, so that it can be heated evenly and rapidly.

In one embodiment, the microwave absorbing material contained in the second feeding device 136 is water, and the microwave absorbing material is sprayed and added to the crushed homogeneous material 181 heated by microwaves on the conveyor belt 150. The crushed homogeneous material 181 heated by the microwave on the conveyor belt 150 is sprayed with water above the second feeding device 136 inside the second microwave suppression chamber 130b, and its temperature drops below 60 degrees. In one embodiment, the second feeding device 136 is a plastic hose or the fluid pipeline, such as a glass tube. The microwave absorbing material in the second feeding device 136 is selected from one of water, refrigerant or ionized water. The second feeding device 135 surrounds the second microwave suppression chamber 130b and has a plurality of holes (not shown) for spraying microwave absorbing material onto the crushed homogeneous material 181 heated by microwaves on the conveyor belt 150. The second feeding device 136 is preferably a water circle containing water, which flows through a cooling device (not shown in the FIG.) and then enters the second feeding device 136 to achieve a cooling cycle. The weight of the microwave absorbing material of the crushed homogeneous material 181 sprayed onto the conveyor belt 150 is less than one-fifth of the weight of the pulverized homogeneous material 181 on the conveyor belt 150. Thus, the present invention can adopt appropriate processing mechanisms to cool down the soil to discharge smoothly and safely before discharging.

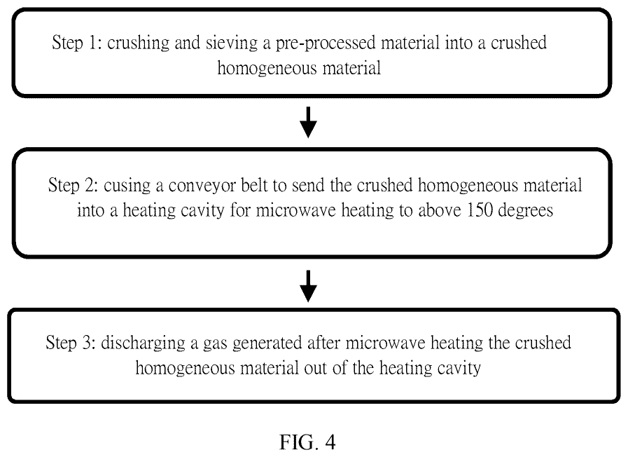

Cooperating with the FIGS. 1, 2, and 3, please refer to FIG. 4, it is a flow chart of the microwave heating process for desorbing contaminated soil of the present invention.

A microwave heating process for desorbing contaminated soil of the presented invention comprises the following steps of:
crushing and sieving a pre-processed material into a crushed homogeneous material, the moisture content of the crushed homogeneous material is between 5% and 40%, and the particle size of the crushed homogeneous material is not greater than 5 cm;
using a conveyor belt to send the crushed homogeneous material into a heating cavity for microwave heating to above 150 degrees; and
discharging a gas generated after microwave heating the crushed homogeneous material out of the heating cavity.

The crushed homogeneous material further includes a step of before entering the heating cavity: spraying a first microwave absorbing material onto the crushed homogeneous material.

The crushed homogeneous material further includes a step of after entering the heating cavity: spraying a second microwave absorbing material onto the crushed homogeneous material.

The soil plasticity index of the crushed homogeneous material is lower than 10.

The pre-processed material 180 includes soil polluted by volatile organic compounds, semi-volatile organic compounds, organic pesticides, petroleum hydrocarbons, polychlorinated biphenyls, and polybrominated biphenyls. The content of organic pollutants in the crushed homogeneous material 181 is no more than 80%, preferably no more than 60%. The soil moisture content of the crushed homogeneous material 181 is between 40%-5%, preferably between 30%-15%. The particle size of the crushed homogeneous material 181 is not greater than 5 cm, preferably no more than 3 cm, preferably less than 1 cm. The soil pH of the crushed homogeneous material 181 is not less than 3, preferably not less than 4. The soil plasticity index of the crushed homogeneous material 181 is less than 12, preferably less than 10.

The first microwave absorbing material is selected from one of water, carbon black, silicon carbide, activated carbon, oxide materials, metal strips, and metal particles, and the microwave absorbing material is sprayed and added to the crushed homogeneous material 181 heated by microwaves on the conveyor belt 150. Preferably, the first microwave absorbing material is selected from one of water and carbon black.

The second microwave absorbing material is selected from one of water, carbon black, silicon carbide, activated carbon, oxide materials, metal strips, and metal particles, and the microwave absorbing material is sprayed and added to the crushed homogeneous material 181 heated by microwaves on the conveyor belt 150. Preferably, the second microwave absorbing material is selected from one of water and carbon black.

In summary, the microwave heating system and process of the presented invention has the following effects:
1. Easy to manufacture and integrate the system;
2. Cost reduction of the system manufacturing;
3. Rapid heating and cooling of soil materials;
4. Reaching the safe value of microwave energy;
5. Entering and exiting the microwave cavity smoothly;
6. Heating materials evenly.

Many modifications and other embodiments of the present disclosure set forth herein will come to mind to one skilled in the art to which the present disclosed subject matter pertains having the benefit of the teachings presented in the foregoing descriptions and the associated drawings. Therefore, it is to be understood that the present subject matter is not to be limited to the specific embodiments disclosed and that modifications and other embodiments are intended to be included within the scope of the appended claims. Although specific terms are employed herein, they are used in a generic and descriptive sense only and not for purposes of limitation.

It will be understood that various details of the presently disclosed subject matter may be changed without departing from the scope of the presently disclosed subject matter. Furthermore, the foregoing description is for the purpose of illustration only, and not for the purpose of limitation.

### SYMBOL DESCRIPTION

100 microwave heating system for desorbing contaminated soil, 110 heating cavity, 112a inlet opening, 112b outlet opening, 120 microwave power source, 122 microwave energy, 130 microwave suppression cavity, 130a first microwave suppression cavity, 130b second microwave suppression cavity, 132 suppression structures, 134a soft conductive material, 134b soft conductive material, 135 first feeding device, 136 second feeding device, 137 spraying direction, 138 spraying direction, 140 exhaust module, 150 conveyor belt, 155 roller, 180 pre-processed material, 181 crushed homogeneous material, 190 feeding module, 190a crushing mechanism, 190b screening mechanism, H height.

What is claimed is:

1. A microwave heating system for desorbing contaminated soil, comprising:
a feeding module for crushing and sieving a pre-processed material into a crushed homogeneous material, the moisture content of the crushed homogeneous material is between 5% and 40%, and the particle size of the crushed homogeneous material is not greater than 5 cm;
a heating cavity, the heating cavity has a plurality of microwave power sources, and has an inlet opening and an outlet opening on opposite sides;
a first microwave suppression cavity, docked with the inlet opening of the heating cavity, and the first microwave suppression cavity contains a plurality of suppression structures;
a second microwave suppression cavity, docked with the outlet opening of the heating cavity, and the second microwave suppression cavity contains a plurality of suppression structures;
a conveyor belt, for transporting the crushed homogeneous material that needs to be heated by microwaves from the feeding module, entering the first microwave suppression cavity, then entering the heating cavity, and finally entering the second microwave suppression cavity before outputting;
a feeding device, arranged above the inside of the first microwave suppression cavity or the second microwave suppression cavity, and the feeding device contains a microwave absorbing material; and
an exhaust module, connected to the heating cavity, used to discharge the gas generated by heating the crushed homogeneous material out of the heating cavity.

2. The microwave heating system for desorbing contaminated soil as described in claim 1, wherein the feeding module includes a crushing mechanism for crushing the pre-processed material into a crushed material with a particle size not greater than 5 cm; and a sieving mechanism for passing the crushed material through the sieving mechanism to obtain the crushed homogeneous material.

3. The microwave heating system for desorbing contaminated soil as described in claim 1, wherein the feeding device is arranged above the inside of the first microwave suppression cavity, and has a spraying element which can spray and add the microwave absorbing material to the crushed homogeneous material on the conveyor belt.

4. The microwave heating system for desorbing contaminated soil as described in claim 1, wherein the feeding device is arranged above the interior of the first microwave suppression cavity, and is a fluid pipeline with a plurality of openings to spray and add the microwave absorbing material to the crushed homogeneous material on the conveyor belt.

5. The microwave heating system for desorbing contaminated soil as described in claim 1, wherein the feeding device is arranged above the inside of the second microwave suppression cavity, and has a spraying element which can spray and add the microwave absorbing material to the crushed homogeneous material on the conveyor belt.

6. The microwave heating system for desorbing contaminated soil as described in claim 1, wherein the feeding device is arranged above the inside of the second microwave suppression cavity, and is a fluid pipeline with a plurality of openings, and the microwave absorbing material is sprayed and added to the crushed homogeneous material on the conveyor belt.

7. A microwave heating process for desorbing contaminated soil, comprising the following steps:
crushing and sieving a pre-processed material into a crushed homogeneous material, the moisture content of the crushed homogeneous material is between 5% and 40%, and the particle size of the crushed homogeneous material is not greater than 5 cm;
using a conveyor belt to send the crushed homogeneous material into a heating cavity for microwave heating to above 150 degrees; and
discharging a gas generated after microwave heating the crushed homogeneous material out of the heating cavity.

8. The microwave heating process for desorbing contaminated soil as described in claim 7, wherein the crushed homogeneous material further includes a step of before entering the heating cavity:
spraying a first microwave absorbing material onto the crushed homogeneous material.

9. The microwave heating process for desorbing contaminated soil as described in claim 7, wherein the crushed homogeneous material further includes a step of after entering the heating cavity:
spraying a second microwave absorbing material onto the crushed homogeneous material.

10. The microwave heating process for desorbing contaminated soil as described in claim 7, wherein the soil plasticity index of the crushed homogeneous material is lower than 10.
